(19) United States
(12) Patent Application Publication
(10) Pub. No.: US 2008/0159585 A1
(43) Pub. Date: Jul. 3, 2008

(54) Statistical Categorization of Electronic Messages Based on an Analysis of Accompanying Images

(75) Inventors: Sean Daniel True, Natick, MA (US); Roger L. Matus, Boxborough, MA (US); Charles Ingold, Bedford, MA (US)

Correspondence Address: NORMA E HENDERSON;HENDERSON PATENT LAW, 13 JEFFERSON DR, LONDONDERRY, NH, 03053, US

(73) Assignee: INBOXER, INC., Concord, MA (US)

(21) Appl. No.: 11/816,274

(22) PCT Filed: Feb. 14, 2006
(86) PCT No.: PCT/US2006/005255

§ 371 Date: Aug. 14, 2007

Related U.S. Application Data
(60) Provisional application No. 60/652,947, filed on Feb. 14, 2005.

(51) Int. Cl. G06K 9/00

(52) U.S. Cl. 382/100

(57) ABSTRACT

A system for categorizing electronic messages is based on analysis of images within them. Information is extracted about potential text areas in an image and represented as a series of bounding polygons that circumscribe the text-containing regions of the image. Descriptive information and statistics are extracted from the set of bounding polygons and a set of textual representations suitable for pattern matching or Bayesian analysis is produced. The derived categorization may be used to drive classification-based engines. In an electronic message classifier, the classifier derives information from at least one textual token for use in making a probabilistic classification of the electronic message.

### RELATED APPLICATION

This application claims the benefit of U.S. Provisional Application Ser. No. 60/652,947, filed Feb. 14, 2005, the entire disclosure of which is herein incorporated by reference.

### FIELD OF THE INVENTION

The invention relates to electronic communications and, in particular, to classification of electronic messages into categories.

### BACKGROUND

Electronic messages, such as email, instant messages, and web pages, are increasingly used to deliver information. Electronic messages that are predominantly text are relatively easy to categorize using simple pattern matching or Bayesian analysis. This categorization is very important in the detection of unwanted inbound messages (e.g. spam) and is increasingly important in the detection of unwanted or unauthorized transmission of confidential, proprietary, or inappropriate information in outbound messages.

It is possible to hide information from casual analysis, such as by typical spam filters, by placing it within images, such as in the form of digitized text.

This technique is increasingly used by purveyors of spam to cause their unwanted messages to defeat spam filters and reach their targets. An existing, straightforward, approach for automatic categorization of messages containing digitized text in images is to convert the images into text using optical character recognition techniques and to then apply a text recognition or categorization technique, such as, for example, pattern matching or Bayesian analysis, to the resulting text. This approach does not typically work well because the error rate in character recognition is unacceptably high. What has been needed, therefore, is a system for analyzing images containing text that allows the messages containing the images to be accurately categorized without the need to extract the exact content of the text.

### SUMMARY

In a method and system for categorizing electronic messages based on an analysis of the images within them, a robust message categorization occurs even when the text in the images cannot be reliably extracted. In one aspect, the present invention extracts information about potential text areas in the image. This information is then represented as a series of bounding polygons that circumscribe the regions of the image that contain text. Descriptive information and statistics are extracted from the set of bounding polygons and a set of textual representations suitable for pattern matching or Bayesian analysis is produced. The derived categorization may then be used to drive spam detection and/or security/policy engines.

Given a set of preclassified messages and their accompanying images, a suitable text representation may be computed to drive the training of a probabilistic classifier. Scores and/or rules that are produced using other message analysis techniques may also be utilized in the present invention, either as an alternative to values obtained using the tokenization method or in combination with them.

In one aspect, the present invention is a method for classifying electronic messages containing images. The method includes the steps of determining at least one bounding polygon for a region that is likely to contain text in an image in an electronic message, extracting at least one item of descriptive information from the bounding polygon, producing at least one textual representation of the region that is likely to contain text, and classifying at least one message utilizing the textual representation. In another aspect, the present invention is an electronic message classifier, the classifier deriving at least one piece of information from at least one textual token for use in making a probabilistic classification of the electronic message, the textual token being derived from at least one description of at least one derivable property of an image accompanying the electronic message.

### BRIEF DESCRIPTION OF THE DRAWINGS

FIG. 1 is an example of an image that contains text;

FIG. 2 depicts the sample text of FIG. 1 and the coordinates of an illustrative bounding polygon for the text;

FIG. 3 depicts another representative image containing text;

FIG. 4 depicts an example overlay of the text region analysis for the image of FIG. 3;

FIG. 5 is a functional flowchart depicting the handling of a single message and its translation into tokens suitable for training a classifier and/or for using a classifier to make a probabilistic classification according to the present invention;

FIG. 6 depicts the steps of training a probabilistic classifier based on a pre-classified message according to the present invention;

FIG. 7 depicts the use of the classifier trained in FIG. 6, according to the present invention;

FIG. 8 depicts the creation of a probabilistic classifier from a set of pre-classified messages according to the present invention; and

FIG. 9 depicts example software modules comprising a preferred embodiment of the system for use in training a classifier according to the present invention.

### DETAILED DESCRIPTION

The present invention is a method and system for categorizing messages based on an analysis of the images within them. The present invention uses preliminary means to extract information about potential text areas in the image. This information is then represented as a series of bounding polygons that circumscribe the regions of the image that contain text. The present invention therefore allows a robust message categorization to occur, even when the text in the images cannot be reliably extracted. The derived categorization can then be used to drive, for example, but not limited to, a spam detection engine (for inbound messages) and/or a security/policy engine (for outbound messages).

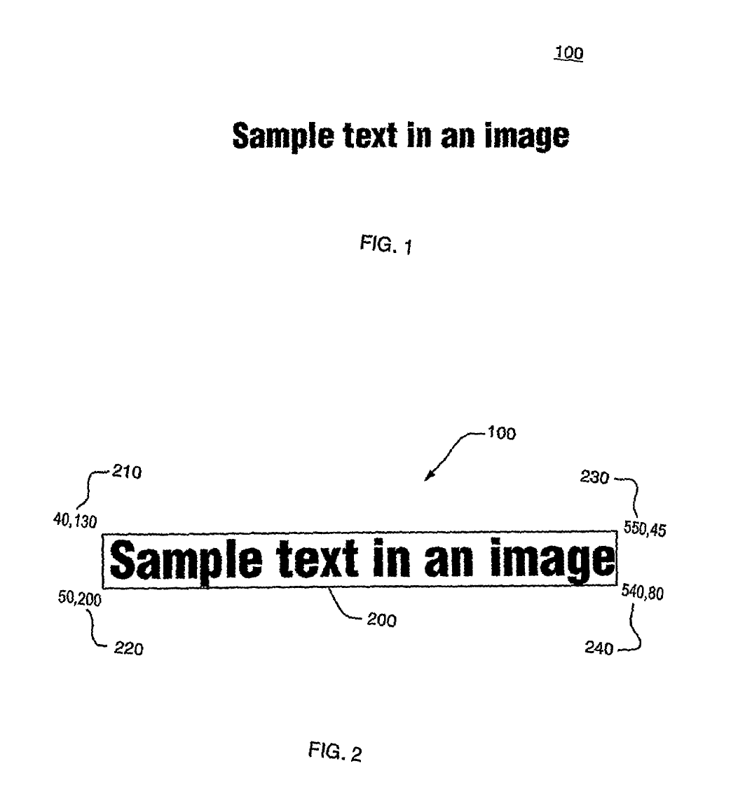

The first step in the method of the present invention is to analyze an image and determine bounding polygons for regions that probably contain text. FIG. 1 is an example of an image that contains text. In FIG. 1, text 100 is a digitized portion of an image file, so it is not detectable or decipherable by programs designed solely to respond to or act on text-based files.

In one embodiment of the method of the present invention, a bounding polygon for the text in the image is found using technical means. FIG. 2 depicts sample text 100 of FIG. 1, surrounded by illustrative bounding polygon 200. Location coordinates 210, 220, 230, 240 are then identified for the comers of bounding polygon 200.

In this embodiment, bounding polygon 200 and coordinate information 210, 220, 230, 240 are then used to derive descriptions that can be either pattern matched or subjected to Bayesian analysis, support vector analysis, neural network analysis, or other any other means of discrimination known in the art that is based on automatic learning from sets of example data. To start, polygon 200, and any other polygons found in the image, are described in a straightforward text format. Table 1 depicts the text representation of bounding polygon 200 for the example image of FIGS. 1 and 2.

TABLE 1

<file = “textexample.png”>
<line bbox = ″(40,130) ,(550,45) (540,80), (50,200)″>
</file>

The description of Table 1 may then be subjected to one or more analysis methods.

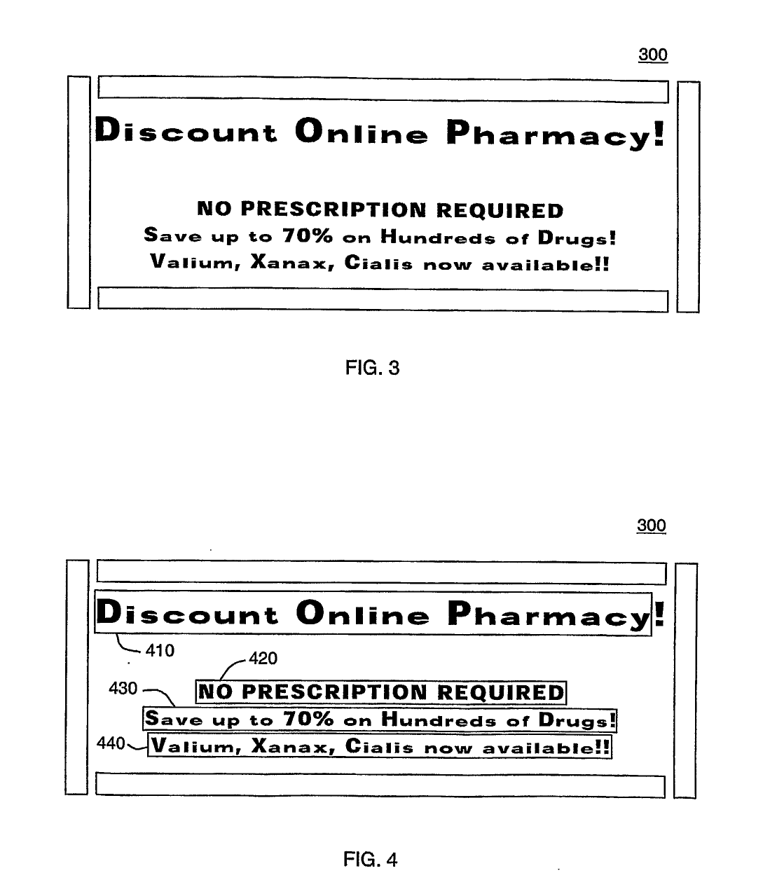

In another embodiment of the present invention, the text regions within an image may be identified using an analysis program. As an example, FIG. 3 depicts a more complex, representative image 300 containing multiple lines of text. In this embodiment, image 300 is analyzed systematically to produce a representation of the text it contains. The system providing this analysis may include commercially available and readily licensable technology, such as that available from Stanford Research International (SRI) or other optical character recognition vendors such as ScanSoft, custom proprietary software, or any other suitable system known in the art. The system utilized needs to be enabled to output the locations of text instead of the corresponding text translation. Such information is ordinarily available during the initial phases of character recognition, and such an adaptation should be straightforward to anyone versed in the art of optical character recognition. The system produces an output, shown in Table 2, which is equivalent to the results of the simple text region analysis applied in the example of FIGS. 1 and 2.

TABLE 2
<file = imagespam_imagespam-0028.txt-http_a6.spoilt7777rneds.com_pills_c09_01.gif>
<line bbox = “(18, 18) (421, 19) (421, 48) (17, 47)”>
<line bbox = “(58, 150) (389, 150) (389, 165) (58, 165)”>
<line bbox = “(79, 79) (356, 79) (355, 95) (78, 95)”>
<line bbox = “(45, 113) (395, 113) (395, 132) (45, 132)”>

Other methods of representing the results of the text region analysis are also suitable for use in the present invention, and any other systematic form of representation known in the art would also be suitable.

FIG. 4 depicts an overlay of the text region analysis of Table 2, illustrating the results obtained from the prior analysis step applied to the image of FIG. 3. Each line of text in image 300 is shown bounded by its own polygon 410, 420, 430, 440. This graphical overlay of the bounding polygons of Table 2 shows that polygons 410, 420, 430, 440 generally correspond to the locations in the image that contain text. It is not important that this correspondence be exact or precise.

In one embodiment of the present invention, the next step is to extract descriptive information and statistics from the previously derived set of bounding polygons. From the bounding polygons, it is then straightforward to compute a set of numerical features, such as:
1. The number of text areas present
2. The aspect ratio of each text area (height/width, expressed as a integer range centered at a determined value corresponding to 1.0)
3. The average aspect ratio of the text areas
4. The total area covered by text (in pixels)
5. The total area of the image (in pixels)
6. The percentage of the image covered by text, expressed as a positive integer 0-100
7. The log2 of all these descriptions, reduced to a positive integer
8. The log10 of all these descriptions, reduced to a positive integer
   Not all of these measures are needed, and many possible subsets carry sufficient information to perform the probabilistic classification. The parameters selected will depend to some extent on the classifier to be used. For some classifications, log2 (feature 7) appears to be the most useful.

In a preferred embodiment of the present invention, the next step is to produce a set of textual representations suitable for pattern matching or Bayesian analysis. As shown in the sample code provided in Table 4, in this step, the image statistics calculated in the previous step are converted, using simple text formatting, into text tokens that can be used in a conventional pattern matching or tokenization engine. Any formatting method that preserves the nature of the feature being described and the numerical value as part of a single token is suitable for use in the present invention. The log2 and log10 conversions of the quantities derived are particularly appropriate because they reduce the number of distinct tokens generated and capture the sense that differences between small numbers are more significant than the same absolute differences between large numbers.

In the example shown in Table 3, which is derived from the image of FIG. 3, each token is composed of a leader (ta: text area), a feature (lines: number of text regions), a scaling denotation (12: log2), and a positive integer.

TABLE 3
ta:areapercent:l2:5 # log2(percentage of the image containing text)
ta:areapercent:l10:1 # log10(percentage of the image containing text)
ta:area:l2:16 # log2(total image area)
ta:area:l10:4 # log10(total image area)
ta:textarea:l2:14 # log2(total text area)
ta:textarea:l10:4 # log10(total textarea)
ta:lines:l2:2 # log2(number of text regions)
ta:lines:l10:0 # log10(number of text regions)

Other methods of representing the tokenization are also possible and suitable for use in the present invention, and any other systematic form of representation known in the art would also be suitable.

Given a set of preclassified messages and their accompanying images, it is straightforward to compute a suitable text representation to drive the training of a probabilistic classifier. Such computation can be performed in any ordinary programming language, although the currently preferred embodiment is in Python. Additional programming languages that would be highly suitable include Perl, Java, C++, Lisp, Visual Basic, and C#, but any other such language known in the art could also be employed. An example script for computing a training set of tokens from precategorized messages is shown in Table 4, which is a Python script that produces a set of textual descriptions suitable for Bayesian analysis from a set of bounding polygons in images.

TABLE 4
# This script extracts meta data from the image files
# And creates text files which have token sets
# import standard supporting modules
from BeautifulSoup import BeautifulStoneSoup
import Image, ImageDraw
import os
import sys
import glob
import time
# locate all files which are present which contain image descriptions
# as computed by the supporting software.
xmlfiles = glob.glob(“text.xml”)
# create a map of all image files contained the
# image descriptions as they occur in the filesystem
imagefilemap = { }
imagefiles = glob.glob(“ximages\\*”)
for file in imagefiles:

name = os.path.basename(file)
name,ext = os.path.splitext(name)
imagefilemap[name.lower( )] = file

# compute a area of a two-dimensional polygon based on a list of its
# boundary points
def area2D_Polygon(V):

area = 0.0
v = V[:] + V[0:2]
for i in range(1, len(V)):

j = i + 1
k = i − 1
area += v[i][0] * (v[j][1] − v[k][1])

return int(area / 2.0)

# convert a floating-point number into a text token of its log 2
def log2(x):

import math
try:

res = int(math.log(x,2))

except:

res = −1

return “l2:%s” % res

# convert a floating-point number into a text token of its log 2
def log10(x):

import math
try:

res = int(math.log(x,10))

except:

res = −1

return “l10:%s” % res

# for a given category such as text area percentage
# generate a list of tokens for analysis
def measure(cat,x):

format = “ta:%s:” % cat + “%s”
return format % log2(x), format % log10(x)

# define a class which will accumulate descriptive tokens for messages
# for all images which are included in the message
class MetaData:

def_init_(self):

self.accumulator = { }

def save(self):

for (message,classification), (area, tarea, count) in self.accumulator.items( ):

if classification == “ham”:

dir = “MetaImageHam”

else:

dir = “MetaImageSpam”

try:

percentage = int(100. * tarea / area)

except:

percentage = 0

# compute summary measures for the message
# across all attached images
measures = list(measure(“totalareapercent”, percentage))
measures += list(measure(“totalarea”, int(area)))
measures += list(measure(“totaltextarea”, int(tarea)))
measures += list(measure(“totallines”, int(count)))
f = open(os.path.join(dir, message),“a”)
print >>f, “ ”.join(measures),“ ”,
f.close( )

def measure(self, message, classification, area, tarea, count,prefix=“”):

print message, classification
if classification == “ham”:

dir = “MetaImageHam”

else:

dir = “MetaImageSpam”

f = open(os.path.join(dir, message),“a”)
try:

percentage = int(100. * tarea / area)

except:

percentage = 0

measures = list(measure(“areapercent”, percentage))
measures += list(measure(“area”, int(area)))
measures += list(measure(“textarea”, int(tarea)))
measures += list(measure(“lines”, int(count)))
larea, ltarea, lcount = self.accumulator.get((message,classification),(0,0,0))
self.accumulator[message,classification] = (larea+area, ltarea+tarea, lcount+count)
print >>f, “ ”.join(measures),“ ”,
f.close( )

# prepared to generate descriptions for set of messages
# and their corresponding images
meta = MetaData( )
# delete the current descriptions of the messages and their images
os.system(“del /q MetaImageSpam”)
os.system(“del /q MetaImageHam”)
# for each file in the input data set
for file in xmlfiles:

# parse the file and extract the images which were attached to it
soup = BeautifulStoneSoup( )
soup.feed(open(file).read( ))
imagefiles = soup(“file”)
messagename = None
for image in imagefiles:

# for each attached image,
# locate the actual image in the filesystem
name = os.path.basename(image[“name”])
name.ext = os.path.splitext(name)
imagefile = imagefilemap.get(name.lower( ), “”)
imageparts = name.split(“−”)
category = “Unknown”
# for purposes of training the images
# and messages are preclassified
if “spam” in imageparts[0]:

category = “spam”

elif “ham” in imageparts[0]:

category = “ham”

message = imageparts[1]
# accessing image using the standard modules
# to find the size of the original image
try:

im = Image.open(imagefile)

except:

continue

area = im.size[0] * im.size[1]
textarea = 0
# find each text bounding box
lines = image(“line”)
for line in lines:

bbox = line[“bbox”]
bbox = bbox.replace(“, ”,“,”).split( )
v = list(eval(“,”.join(bbox)))
textarea += area2D_Polygon(v)

# add the derived tokens from this image to
# its corresponding message
meta.measure(message, category, area, textarea, len(lines))

meta.save( )

The tokens generated by this process can be treated in the same way that any text is treated. In a preferred embodiment, the tokens are used as input to a Bayesian classification engine in order to provide for discrimination between spam and non-spam messages and/or to provide for detection of, and discrimination between, confidential, proprietary, or other messages that may be restricted by organizational, legal, or personal policy.

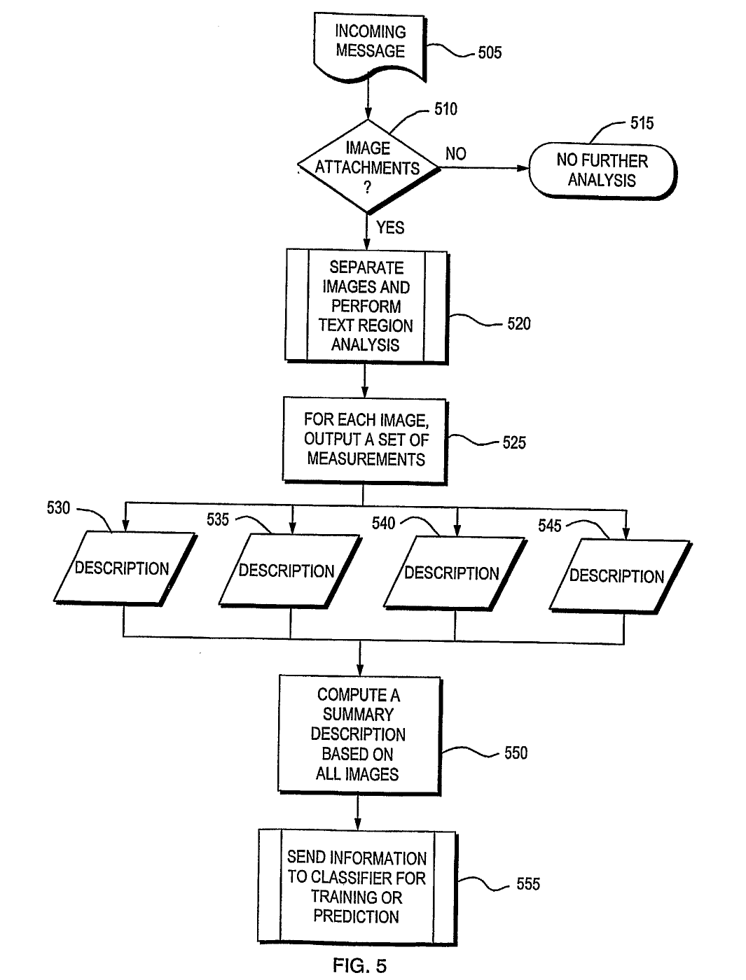

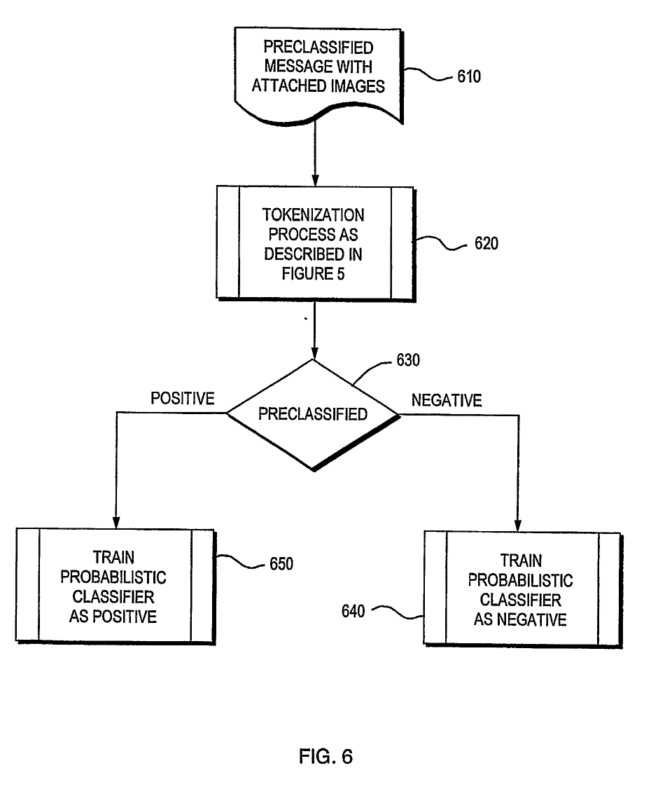

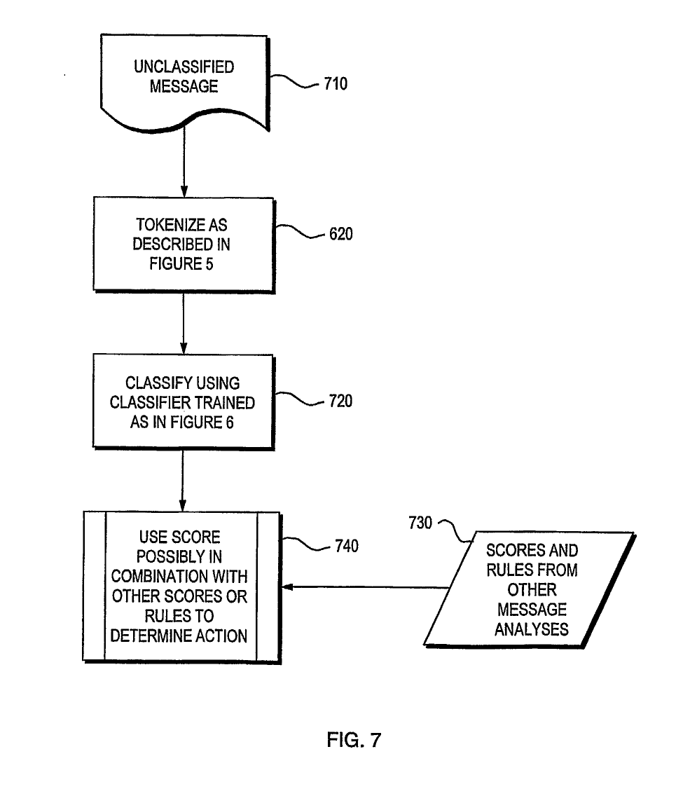

FIG. 5 is a functional flowchart depicting an embodiment of a method for the handling of a single message and its translation into tokens suitable for training a classifier and/or for use by a classifier in making a probabilistic classification, according to one aspect of the present invention. In FIG. 5, an message is received 505 into the translation system. The message is examined 510 for image attachments. If the message does not have any image attachments, no further analysis is performed 515 and the message is sent on its way. If the message does include one or more image attachments, the images are separated and text region analysis is performed 520 on each one to produce a text bounding box or other derived information for each image. This information is then used to output 525 a set of measurements for each image, which is in turn used in the creation of a description 530, 535, 540, 545 for each text region in the image. A summary description for the message is computed 550 based on the information calculated for all images in the message. This summary, the individual images, and all image information, in the form of tokens, is then ready to be sent 555 to a classifier for use in training or prediction functions.

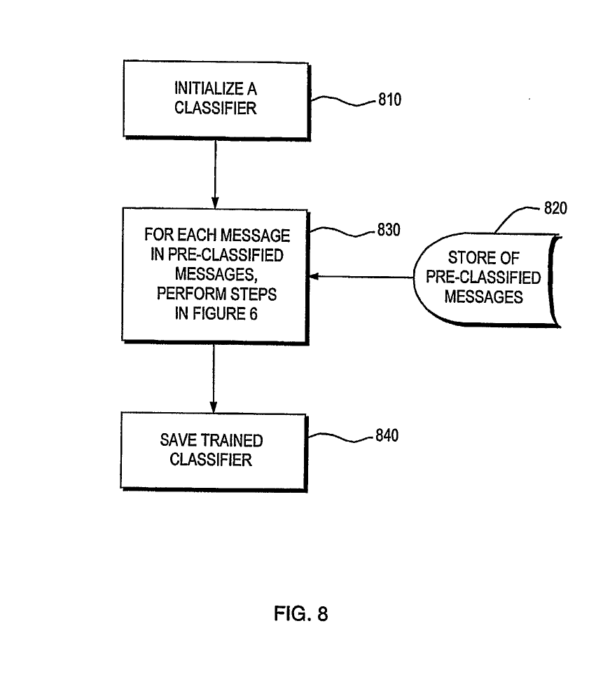

FIG. 6 depicts the steps of training a probabilistic classifier based on a pre-classified message. In FIG. 6, preclassified message 610 with attached images is tokenized 620 according to the method of FIG. 5. If the message was reclassified 630 as negative, the probabilistic classify is taught to classify a message having images with the same tokenization pattern as negative 640. If the message was reclassified 630 as positive, then the probabilistic classify is taught to classify a message having images with the same tokenization pattern as positive 650.

FIG. 7 depicts the use of the classifier trained in FIG. 6, possibly in conjunction with scores or rules from other systems of classification or analysis. In FIG. 7, unclassified message 710 is tokenized 620 by the method of FIG. 5. Next, it is classified 720 using a trainer that has been trained according to the method of FIG. 6. The result produced by the classifier is used, possibly in combination with scores and/or rules from other message analyses 730, to determine 740 the action to be taken with respect to the message.

As shown in FIG. 7, the present invention is not limited to just the use of tokens produced using the method of FIG. 5 as input to the classifier. Scores and/or rules 730 that are produced using other message analysis techniques and may be useful to a probabilistic classifier may also be utilized in the present invention, either as an alternative to values obtained using the tokenization method or in combination with them. For example, the invention may employ values derived from one or more statistical measures of the pixel values in the message images, such as, but not limited to, a histogram, minimum, maximum, mean, average, sum, root-mean-square, variance, and/or standard deviation. The invention may further employ values derived from other aspects of the images associated with a message such as, but not limited to, the area or perimeter of an image, the shape of an image, the colors or palette employed by an image, or an algorithmic analysis based on one or more image-related parameters.

Alternatively, or in addition, the invention may employ an estimation of the information entropy of the message, obtained using a compression or other algorithm, such as by calculating the ratio of the compressed and uncompressed sizes of a file. The classifier of the present invention may also, or alternatively, employ values derived from measurement of the header information for the image and/or from properties of inaccurate information found in the header information. In particular, the detection of a file whose content does not match that indicated by its mime type and/or extension could signal either a mistake or an intention to deceive a classifier.

Information related to other aspects of the message may also be advantageously employed by the classifier of the present invention. This includes, but is not limited to, metadata, such as author, copyright, format, extension, filename, file size, creation date/age, modification date/age, encryption (y/n, scheme), and opacity (foreign language, rota13), information from or associated with the message header, such as the header content, packaging (amount (number and length) of information contained in header fields), routing (number and depth of nested messages), and shipping (number of addresses and/or domains), URLs within the message text (existence, type, content), the length, frequencies, and sampling rates of audio files, the language and length of source code files, the length of video files, the complexity of markup files, and various parameters derivable from computer files, such program files and data files.

FIG. 8 depicts the creation of a probabilistic classifier from a set of pre-classified messages. In FIG. 8, a classifier is initialized 810. A store of preclassified messages 820 is then utilized according to the method of FIG. 6 to train 830 the initialized classifier. The trained classifier is then saved 840.

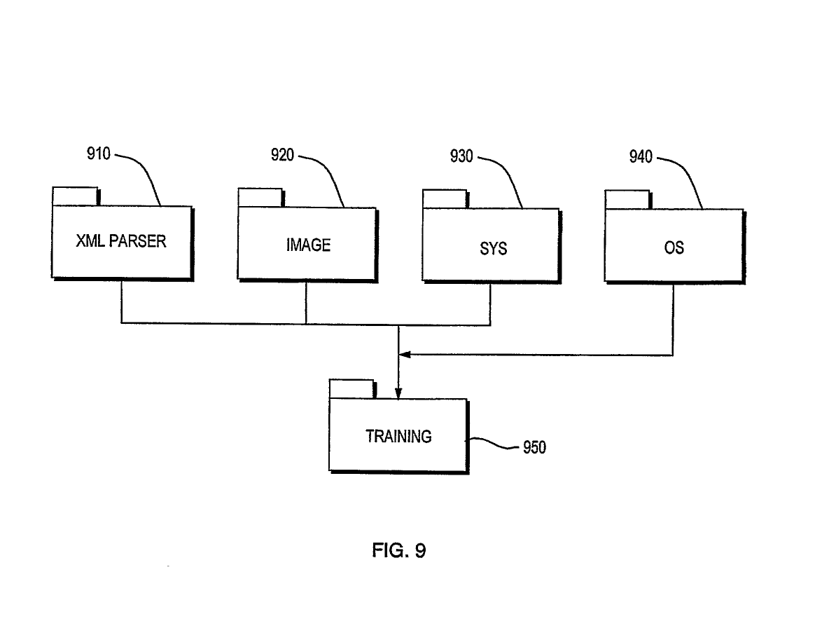

FIG. 9 depicts software modules comprising a preferred embodiment of the system for use in training a classifier according to the method of FIG. 6. In FIG. 9, the system is comprised of XML parser 910, image analyzer 920, Sys module 930, OS 940, and training module 950. XML Parser module 910 can be any parser capable of loading XML into a queryable data structure. Such parsers are commonly available. The BeautifulSoup parser is a simple parser, and is used in the preferred embodiment. Image Analysis module 920 must be capable of extracting potential areas of text or other metadata from an image. Such systems include commercially available and readily licensable technology, such as the one available from Stanford Research International (SRI). Such a system might also be available from other optical character recognition vendors such as ScanSoft. Such a system would need to be enabled to output the locations of text instead of the corresponding text translation.

Sys module 930 comprises the services and libraries necessary to support the chosen programming language. In the preferred embodiments, these are provided by the standard Python runtime library, but could be easily replaced in Python or replicated for other languages by a practitioner versed in the ordinary state of the art. OS module 940 comprises the core operating services and libraries necessary to allow application software to run on the chosen computational platform. Examples of commonly available and suitable platforms include Windows 98, ME, NT, XP, Server 2003, and other Microsoft operating systems; Linux, Unix, and other POSIX compatible operating systems; embedded operating systems such as Symbian, Savaje, or VxWorks; and other system suitable to support the Sys (930) module. While a preferred software embodiment is disclosed, many other implementations will occur to one of ordinary skill in the art and are all within the scope of the invention.

The present invention therefore provides a system for analyzing images containing text that allows the messages containing the images to be accurately categorized without the need to extract the exact content of the text. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

What is claimed is:

1. A method for classifying electronic messages containing images comprising the steps, in combination, of:
determining at least one bounding polygon for a region that is likely to contain text in an image in an electronic message;
extracting at least one item of descriptive information from the at least one bounding polygon; and
producing, from the descriptive information, at least one textual representation, for use in a message classification system, of the region that is likely to contain text.

2. The method of claim 1, wherein the textual representation is suitable for use in a message classification system that employs Bayesian analysis.

3. The method of claim 1, wherein the textual representation is suitable for use in a message classification system that employs pattern matching.

4. The electronic message classifier of claim 1, further comprising the step of classifying at least one message utilizing the textual representation.

5. A memory device, the memory device containing code which, when executed in a processor, performs the steps of:
determining at least one bounding polygon for a region that is likely to contain text in an image in an electronic message;
extracting at least one item of descriptive information from the at least one bounding polygon; and
producing at least one textual representation of the region that is likely to contain text for use in a message classification system.

6. The electronic message classifier of claim 5, wherein the textual representation is suitable for use in a message classification system that employs Bayesian analysis.

7. The electronic message classifier of claim 5, wherein the textual representation is suitable for use in a message classification system that employs pattern matching.

8. The electronic message classifier of claim 5, the memory device further comprising code which, when executed in a processor, performs the step of classifying at least one message utilizing the textual representation.

9. An electronic message classifier, the classifier deriving at least one piece of information from at least one textual token for use in making a probabilistic classification of the electronic message, the textual token being derived from at least one description of at least one derivable property of an image accompanying the electronic message.

10. The electronic message classifier of claim 9, wherein the derivable property is selected from the group consisting of area, geometric shapes, and color.

11. The electronic message classifier of claim 9, wherein the classification is used to determine whether an inbound electronic message is unsolicited or desirable.

12. The electronic message classifier of claim 9, wherein the classification is used to determine whether a potential outbound electronic message is unsolicited or desirable.

13. The electronic message classifier of claim 9, wherein the classification is used to determine whether a potential outbound message sent by a message sender violates at least one policy of at least one organization to which the message sender belongs.

14. The electronic message classifier of claim 13, wherein an action is triggered to prevent or ameliorate a policy violation when a potential policy violation is detected.

15. The electronic message classifier of claim 9, wherein the classification is used to determine whether or not to potential outbound message violates a law or legal requirement.

16. The electronic message classifier of claim 15, wherein an action is triggered to prevent or ameliorate a violation of the law or legal requirement when a potential violation is detected.

17. The electronic message classifier of claim 9, wherein the derivable property is based on an estimation of information entropy of the image.

18. The electronic message classifier of claim 9, wherein the derivable property is based on a statistical measure of pixel values in the image.

19. The electronic message classifier of claim 9, wherein the derivable property is based on a measurement of header information for the image.

20. The electronic message classifier of claim 9, wherein the derivable property is based on inaccurate information found in header information for the image.
